(19) United States
(12) Patent Application Publication
(10) Pub. No.: US 2025/0300290 A1
(43) Pub. Date: Sep. 25, 2025

(54) BATTERY CASE

(71) Applicants: HYUNDAI MOTOR COMPANY, Seoul (KR); KIA CORPORATION, Seoul (KR)

(72) Inventors: Gyung Hoon Shin, Seoul (KR); Jong Gyu Park, Hwaseong-si (KR); Gun Woo Ko, Seongnam-si (KR); Hae Woong Jung, Anyang-si (KR)

(73) Assignees: HYUNDAI MOTOR COMPANY, Seoul (KR); KIA CORPORATION, Seoul (KR)

(21) Appl. No.: 18/808,851

(22) Filed: Aug. 19, 2024

(30) Foreign Application Priority Data
Mar. 19, 2024 (KR) 10-2024-0037995

(51) Int. Cl. H01M 50/242; H01M 10/48; H01M 50/249; H01M 50/271; H01M 50/284; H01M 50/289

(52) U.S. Cl. CPC H01M 50/242; H01M 10/486; H01M 50/249; H01M 50/271; H01M 50/284; H01M 50/289

(57) ABSTRACT

A battery case includes: a plurality of battery cells stacked on one another and accommodated in a battery lower case; an upper cover covering an upper portion of the stacked battery cells; at least one first bracket including a first end and a second end provided to be in contact with an upper surface of the upper cover, and a middle portion spaced apart from the upper surface of the upper cover to form an insertion space; and a battery upper case provided above the battery lower case. In particular, the battery upper case includes a second bracket provided on a lower surface thereof, and the second bracket includes a first end to be inserted in an insertion space formed between the upper surface of the upper cover and the first bracket.

### CROSS REFERENCE TO RELATED APPLICATION

This application claims priority to Korean Patent Application No. 10-2024-0037995, filed Mar. 19, 2024, the entire contents of which are incorporated herein by reference.

### BACKGROUND

### Field of the Disclosure

The disclosure relates to a battery case.

### Description of the Related Art

To reduce the emission of carbon dioxide due to use of fossil fuels, research/development of electric vehicles using a battery and an electric motor instead of an internal combustion engine is being conducted.

A major challenge for the electric vehicles is to increase a distance the electric vehicle can travel on a single charge, which requires increase in the energy density of the battery and decrease in the weight of the electric vehicle.

In particular, the increase in the battery's own energy density and the decrease in the battery's own weight are key technologies of increasing the distance the electric vehicle can travel on the single charge. In other words, the battery's own energy density may be increased by removing some components of the battery and adding battery cells to a space where the removed components were.

To this end, the number of longitudinal and transverse members, which are used variously, e.g., for forming spaces to accommodate battery modules in a battery lower case, may be reduced, and the number of through mounts provided in the longitudinal and transverse members and used for mounting a battery case to the electric vehicle may be reduced.

However, when a resonance frequency occurring upon traveling of the vehicle becomes similar to the natural frequency of the battery as the number of components is decreased, the resonance of the battery accelerates and there is concern about damage to components due to noise and vibration.

The foregoing matters described as the related art are provided only to enhance understanding of the background of the disclosure and should not be taken as an acknowledgement that they are the prior art already known to a person having ordinary skill in the art.

### SUMMARY

The disclosure is conceived to solve such problems, and an aspect of the disclosure is to provide a battery case in which a battery resonance frequency is separated from the vehicle traveling frequency, thereby having an effect on reducing a battery resonance.

According to an embodiment of the disclosure, a battery case includes: a plurality of battery cells stacked on one another and accommodated in a battery lower case; an upper cover covering an upper portion of the stacked battery cells; and at least one first bracket including a first end and a second end provided to be in contact with an upper surface of the upper cover. The at least one first bracket further includes a middle portion spaced apart from the upper surface of the upper cover to form an insertion space. The battery case further includes a battery upper case provided above the battery lower case, and including a second bracket provided on a lower surface thereof. The second bracket includes a first end to be inserted in an insertion space formed between the upper surface of the upper cover and the at least one first bracket.

The battery case may further include at least one foam pad provided between a bottom of the middle portion of the first bracket and a top of the upper cover. The at least one foam pad is configured to face the middle portion and absorb vibration.

The second bracket provided on the lower surface of the battery upper case may include a second end being in contact with the lower surface of the battery upper case, and the first end of the second bracket is bent, extending downwards from the second end and inserted in the insertion space.

A sensing printed circuit board (PCB) for detecting states of the battery cells may be provided above a central portion of the stacked battery cells, and includes a temperature sensor to detect temperature of the battery cells.

The upper cover may include a protruding portion formed at a central position on the upper surface thereof and disposed to be higher than a surrounding portion of the upper surface.

In one embodiment, a pair of first brackets may be provided to spaced apart from the protruding portion. The protruding portion may be disposed between the pair of first brackets. In another embodiment, the pair of first brackets face each other, and the protruding portion is spaced apart from each first bracket of the pair of first brackets.

The first end of the second bracket may be inserted in the insertion space formed between one of the first brackets forming a pair and the upper surface of the upper cover.

The middle portion of the first bracket may be formed to have the same height as or be lower than the protruding portion.

The battery lower case may include a longitudinal member crossing the battery lower case in a lengthwise direction of the battery lower case, and a transverse member crossing the battery lower case in a widthwise direction of the battery lower case, such that an accommodating space is formed to accommodate a battery module including the stacked battery cells therein.

Each of the longitudinal member and the transverse member may be provided as a single member to divide an inside of the battery lower case into four accommodating spaces, each of which accommodates the battery module therein.

The battery lower case may include a management space located at a front end and accommodating a battery management unit therein, and side members provided at both sides of the management space to form outer walls.

The battery case may further include a guide portion formed at a first end portion of a top of the side member, extended in a direction perpendicular to the ground, and guiding the battery upper case to slide.

The guide portion may be formed extending along a lengthwise direction of the battery lower case, but not formed in a second end portion of the side member.

The battery lower case may include a rear member provided at a rear end of the battery lower case and forming a rear wall of the battery lower case.

The rear member may include a stopper formed at a top thereof, extended in a direction perpendicular to the ground, and stopping the sliding of the battery upper case.

The battery lower case may include a longitudinal member crossing the battery lower case in a lengthwise direction of the battery lower case, a transverse member crossing the battery lower case in a widthwise direction of the battery lower case, and sidewall members facing the longitudinal member and forming side walls of the battery lower case.

The longitudinal member, the transverse member, and the sidewall members may form an accommodating space inside the battery lower case to accommodate the battery module therein. The first bracket may be provided on the upper surface of the upper cover corresponding to the accommodating space, and the second bracket may be provided on the lower surface of the battery upper case corresponding to the accommodating space.

According to the disclosure, there is provided a battery case, in which a battery resonance frequency is separated from a vehicle traveling frequency, thereby having an effect on reducing a battery resonance.

### BRIEF DESCRIPTION OF THE DRAWINGS

FIG. 1 is an exploded perspective view of a battery lower case and a battery upper case, which make up a battery case according to an embodiment of the disclosure.

FIG. 2 shows a battery lower case.

FIG. 3 shows the bottom of a battery upper case.

FIG. 4 is an exploded perspective view of a battery module.

FIG. 5 is an enlarged view of an upper surface of an upper cover.

FIG. 6 shows a cross-section taken along line A-A′ in FIG. 1.

FIG. 7 shows a batter lower case of a battery case according to an embodiment of the disclosure.

FIG. 8 is an enlarged view of a side member.

FIG. 9 is an enlarged view of the rear of a battery lower case.

### DETAILED DESCRIPTION

Hereinafter, embodiments of the present disclosure are described in detail with reference to the accompanying drawings, in which the same or similar elements are denoted by the same reference numerals even though they are depicted in different drawings and redundant descriptions thereof are avoided.

In terms of describing the embodiments of the present disclosure, detailed descriptions of related art are omitted when they may make the subject matter of the embodiments of the present disclosure rather unclear. In addition, the accompanying drawings are provided only for a better understanding of the embodiments of the present disclosure and are not intended to limit technical ideas of the present disclosure. Therefore, it should be understood that the accompanying drawings include all modifications, equivalents and substitutions within the scope and spirit of the present disclosure.

Terms such as “first” and “second” may be used to describe various components, but the components should not be limited by the above terms. In addition, the above terms are used only for the purpose of distinguishing one component from another.

Unless the context clearly dictates otherwise, singular forms include plural forms as well.

In the present disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

When a component, device, element, or the like of the present disclosure is described as having a purpose or performing an operation, function, or the like, the component, device, or element should be considered herein as being “configured to” meet that purpose or to perform that operation or function.

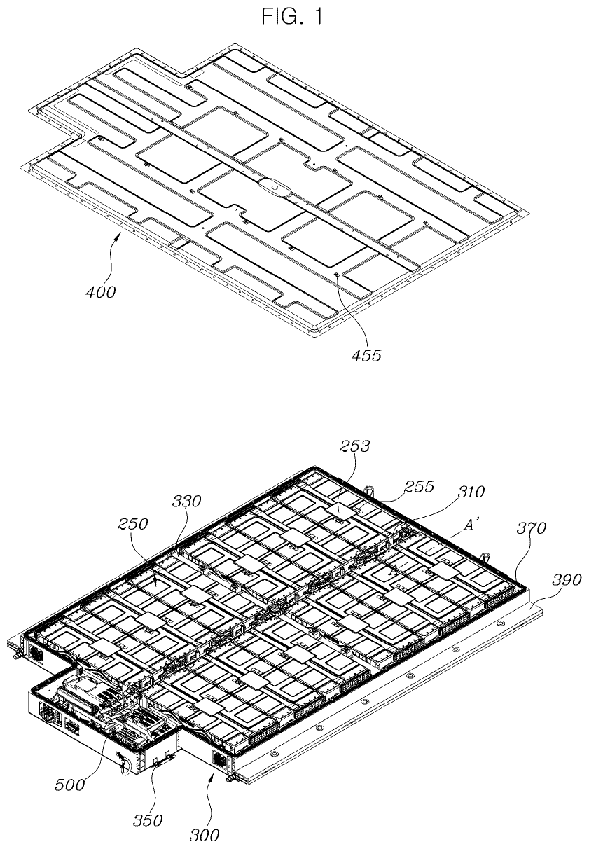

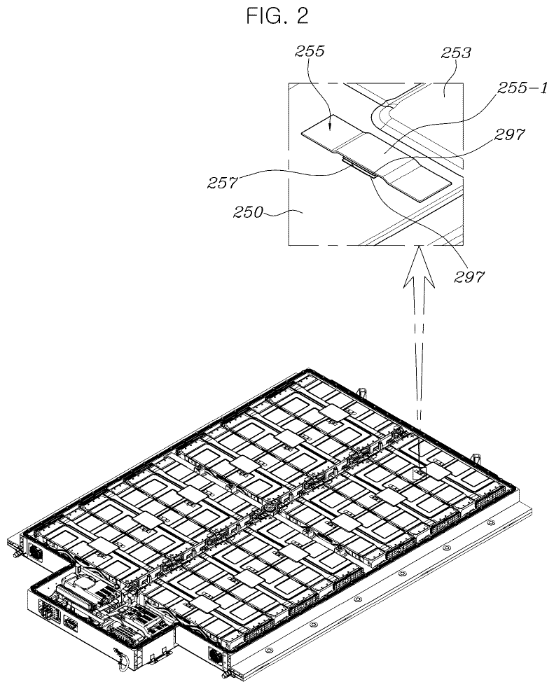

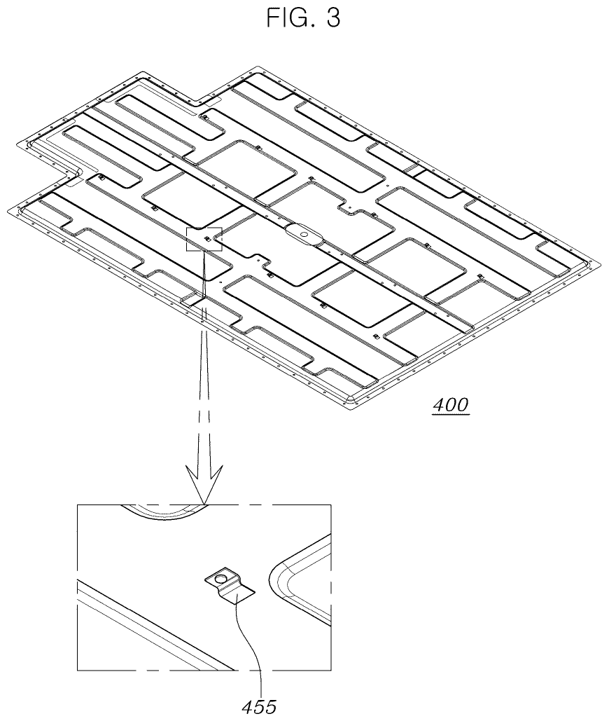

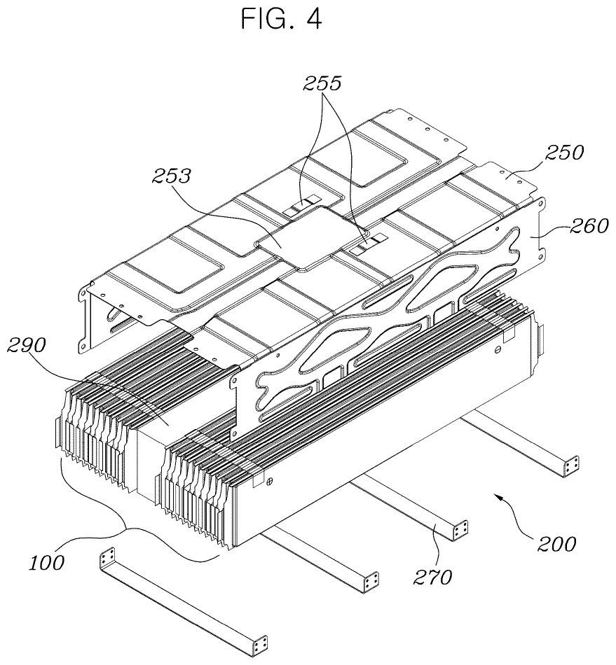

FIG. 1 is an exploded perspective view of a battery lower case and a battery upper case, which make up a battery case according to an embodiment of the disclosure, FIG. 2 shows a battery lower case, FIG. 3 shows the bottom of a battery upper case, and FIG. 4 is an exploded perspective view of a battery module.

The present disclosure is described with reference to FIGS. 1-4 and 7.

Referring to FIG. 4, a plurality of battery cells 100 are stacked to form a group. For example, twelve (12) battery cells may be stacked on one another and grouped into one battery module. Further, an end plate 260 and an upper cover 250 may be provided to cover and protect the group of battery cells from external shocks and form appropriate surface pressure on the battery cells. The lower clamps 270 are provided under the group of battery cells, thereby firmly holding the group of battery cells.

In one embodiment, a space may be formed above the center of the battery cell group. An electronic device for detecting or monitoring the states of the battery cells or a wire for connection between the electronic device and the battery cells passes through the space formed above the center of the battery cell group.

A battery module 200 may include the foregoing components, and a plurality of battery modules 200 may be accommodated in a battery lower case 300. In addition, a battery managing system (BMS), a cooling system, etc. are further provided, thereby making up a battery system. In other words, the battery system includes the plurality of battery modules 200 accommodated in the battery lower case 300, the battery managing system (BMS), the cooling system.

In one form, the upper cover 250 for covering the top of the battery cells 100 and the end plate 260 for covering the side of the battery cells 100 may be coupled to each other or molded as a single body, thereby protecting the battery cells 100 from external shocks and forming an appropriate surface pressure on the lateral sides of the battery cells 100.

The battery module 200 is accommodated in the battery lower case 300, and a battery upper case 400 is coupled to the battery lower case 300, thereby completing the battery case.

Meanwhile, in order to increase the energy density of the battery, attempts have recently made to decrease the weight of the battery case by removing or reducing some of longitudinal members and transverse members provided inside the battery lower case 300, and place the battery cells in a space formed by removing the longitudinal members and the transverse members.

However, the transverse members and the longitudinal members may be provided with through mounts or the like for mounting the battery case to a vehicle body, and the number of through mounts is decreased as some of the transverse members and the longitudinal members are removed.

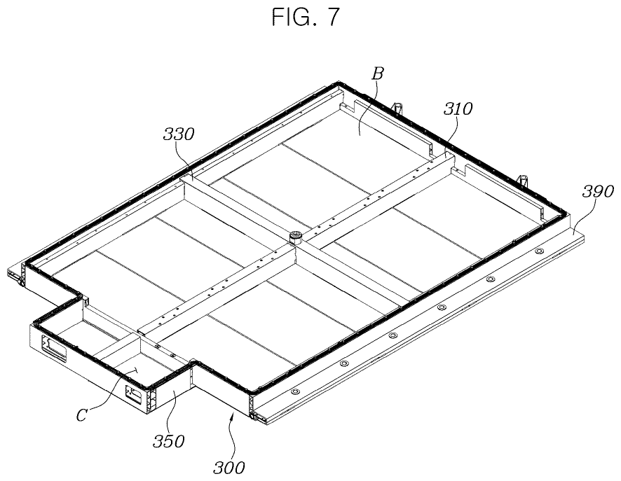

FIG. 7 shows a battery lower case of a battery case according to an embodiment of the disclosure. Referring to FIG. 7, the battery lower case 300 may be internally provided with a longitudinal member 310 crossing the battery lower case 300 in a lengthwise direction, and a transverse member 330 crossing the battery lower case 300 in a widthwise direction of the battery lower case. Further, the battery lower case 300 may be provided with sidewall members 390 in parallel with the longitudinal member 310 and forming the side walls of the battery lower case 300.

Each of the longitudinal member 310 and the transverse member 330 is provided as a single member, and the sidewall members 390 forms a pair, so that the inside of the battery lower case 300 can be divided into four accommodating spaces B, thereby accommodating the battery module 200 in each of the accommodating spaces B.

Although such a battery lower case 300 is capable of accommodating a large number of battery modules 200 therein, there are very few holding points in an upper area of the battery case, in particular, an area corresponding to the accommodating space because the number of through mounts is decreased as some of the longitudinal members and the transverse members are removed.

The upper area of the battery case is vulnerable to vibration, which accelerates the resonance of the battery when a resonance frequency becomes similar to the natural frequency of the battery upon occurrence of the vibration due to traveling of the vehicle. Accordingly, there is concern about damage to components due to noise and vibration.

To solve such problems, first brackets 255 are provided on the upper surface of the upper cover 250 of the battery module 200, and second brackets 455 are provided on a lower surface of the battery upper case 400, so that the second brackets 455 can be fastened to the first brackets 255, thereby forming many holding points on the upper area of the battery case.

In other words, the first brackets 255 are formed on the upper surfaces of the upper covers 250 corresponding to the accommodating spaces B formed by the longitudinal member 310, the transverse member 330, and the sidewall members 390. The second brackets 455 are provided on the lower surface of the battery upper case 400 corresponding to the accommodating spaces B, so that many holding points can be formed at places corresponding to the accommodating spaces B by fastening the second brackets 455 to the first brackets 255, thereby protecting the battery modules 200 from vibration.

Specifically, referring to FIG. 2, the first bracket 255 includes a first end and a second end to be in contact with the upper surface of the upper cover 250. Further, a middle portion 255-1 between the first end and the second end of the first bracket 255 is spaced apart from the upper surface of the upper cover 250 and forms an insertion space 257 to insert the second bracket 455 therein.

Referring to FIG. 3, the second bracket 455 includes a first end to be inserted in the insertion space 257 formed between the first bracket 255 and the upper cover 250 so that the battery upper case 400 and the battery lower case 300 can be coupled to each other. As the first bracket 255 and the second bracket 455 are fastened, the battery upper case 400 can have many holding points.

In other words, as shown in FIG. 1, the first bracket 255 is formed for each battery module 200 because the plurality of battery modules 200 is accommodated in the battery lower case 300. As the second brackets 455 of the battery upper case 400 are inserted sliding into the insertion spaces of the first brackets 255, the frequency based on the traveling of the vehicle is separated from the battery resonance frequency, thereby reducing the battery resonance.

It may be considered to provide the first bracket 255 inside the upper cover 250 of the battery module 200. However, the first bracket 255 provided inside the upper cover 250 may cause cell damage, insulation breakdown, etc. because the inside of the battery module 200 is fully filled with the battery cells and the like. Therefore, it is desired to provide the first bracket 255 outside the upper cover 250 as described above.

Referring to FIGS. 2 and 3, at least one foam pad 297 for absorbing vibration may be provided on the bottom of the middle portion 255-1 of the first bracket 255 and the top of the upper cover 250 facing the middle portion 255-1. In other words, the foam pads 297 are additionally provided on the top of the upper cover 250 and the bottom of the middle portion 255-1 of the first bracket 255 within the insertion space 257, and therefore the elasticity of the foam pad(s) 297 allows the first end of the second bracket 455 to be stably held in the insertion space 257 and absorbs shocks or vibration.

On the lower surface of the battery upper case 400, the second end of the second bracket 455 is in contact with the battery upper case 400, and the first end of the second bracket 455 is bent, extending downwards from the second end and inserted in the insertion space 257. The first end of the second bracket 455 is inserted, sliding into the insertion space 257 which is formed by the first bracket 255 and the upper cover 250.

In another embodiment, referring to FIG. 4, a sensing printed circuit board (PCB) 290 for detecting the states of the battery cells 100 is provided above a central portion of the stacked battery cells 100. In general, the sensing PCB 290 senses the voltages and currents of the battery cells 100 to detect abnormal conditions such as overcharging, overdischarging, short-circuit, and the like of the battery cells 100, so that the battery cells 100 can be protected.

Further, the sensing PCB 290 may include a temperature sensor for sensing the temperatures of the battery cells 100. The temperature sensor senses the temperatures of the battery cells 100 to detect the overheating or low temperature states so that the battery cells 100 can be protected.

In general, a central portion of the battery module 200 has the highest temperature. Therefore, the sensing PCB 290 may be provided above the battery cells 100 while crossing the center of the battery module 200, and the temperature sensor may be provided at the center inside the sensing PCB 290 and the battery module 200. Further, the sensing PCB 290, the temperature sensor, and the wire for connecting the battery cells 100 and electronic components may be positioned at the central portion in the battery module 200.

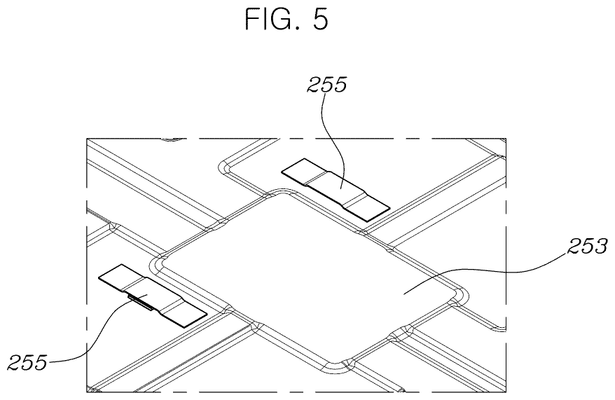

In one embodiment, a protruding portion 253 that is higher than its surrounding portion may be formed at a central position on the upper surface of the upper cover 250. In other words, referring to FIGS. 4-5, the central portion of the upper surface of the upper cover 250 forms the protruding portion 253 to secure a sufficient space where the sensing PCB 290, the temperature sensor, and the wire are placed.

In this case, the first brackets 255 provided on the upper surface of the upper cover 250 are spaced apart with the protruding portion 253 therebetween, and form a pair to face each other. Further, the first end of the second bracket 455 may be inserted in the insertion space 257 formed between one of the first brackets 255 forming one pair and the upper surface of the upper cover 250.

In other words, the second bracket 455 may be fastened to one of the first brackets 255 forming one pair. Specifically, referring to FIG. 1, the battery module 200 positioned on the left and the battery module 200 positioned on the right with respect to the longitudinal member 310 are disposed so that electrical terminals thereof for electrical connection can be oriented toward the longitudinal member 310. Therefore, one pair of first brackets 255 are formed on the upper cover 250 when the battery module 200 is manufactured, and the first bracket 255 located relatively forward between one pair of first brackets 255 is fastened to the second bracket 455.

In one form, the single first bracket 255 may be provided in consideration of the placement of the battery module 200 and the accommodating space B in which the battery module 200 is inserted. However, the production of the single first bracket 255 is inefficient. Accordingly, it is desired to provide the pair of first brackets 255.

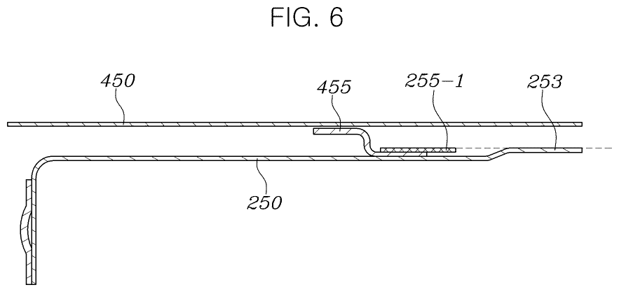

FIG. 6 shows a cross-section taken along line A-A′ in FIG. 1. Referring to FIG. 6, the middle portion 255-1 of the first bracket 255 may be formed to have the same height as or be lower than the protruding portion 253. Specifically, the protruding portion 253 of the upper cover 250 has the highest height in the upper cover 250. Because the protruding portion 253 has the highest height in the upper cover 250, the sensing PCB 290, the temperature sensor or various wires are placed to pass through the protruding portion 253. Meanwhile, when the height of the middle portion 255-1 of the first bracket 255 is equal to or lower than that of the protruding portion 253, it is advantageous to maintain the size of the battery case. In other words, when the height of the middle portion 255-1 of the first bracket 255 is higher than that of the protruding portion 253, the size of the battery case naturally increases, thereby decreasing the energy density of the battery.

Therefore, the middle portion 255-1 of the first bracket 255 is formed to have the same height as or be lower than the protruding portion 253, thereby increasing or at least maintaining the energy density of the battery while maintaining the size of the battery case.

Meanwhile, the battery lower case 300 includes a management space C located at a front end and accommodating a battery management unit 500, and side members 350 provided on both sides of the management space C, forming outer walls.

Specifically, referring to FIG. 7, the battery management unit 500 for monitoring the voltage, current, temperature, charging and discharging states of the battery cells or battery modules may be provided in the management space C located at the front end of the battery lower case 300.

The side members 350 are provided on both sides of the management space C and form the outer walls to cover the battery management unit 500, thereby protecting the battery management unit 500 from external shocks.

In addition, a guide portion 355 for guiding the battery upper case 400 to slide may be formed at a first end portion of the top of the side member 350 and extended in a direction perpendicular to the ground.

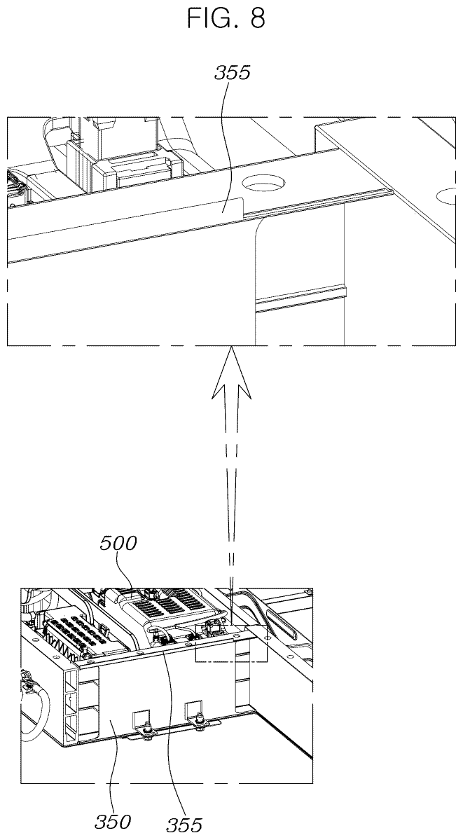

FIG. 8 is an enlarged view of a side member. Referring to FIG. 8, the guide portion 355 for guiding the sliding of the battery upper case 400 is formed on the top of the side member 350 and extended in the direction perpendicular to the ground.

The guide portion 355 extends along the lengthwise direction of the battery case, thereby guiding the battery upper case 400 to slide. In particular, the guide portion 355 may be formed extending along the lengthwise direction of the battery case at the first end portion of the top of the side member 350, but not formed at a second end portion of the side member 350.

In other words, the battery upper case 400 slides so that the first end of the second bracket 455 can be inserted in the insertion space 257 formed between the first bracket 255 and the upper cover 250. Accordingly, it is required to set a position where the sliding of the battery upper case 400 starts, and a position where the sliding of the battery upper case 400 ends.

In other words, when the battery upper case 400 starts sliding at the second end portion where the guide portion 355 is not formed, the battery upper case 400 may slide a certain distance as long as the distance where the guide portion is not formed, and thus the first bracket 255 and the second bracket 455 are fastened.

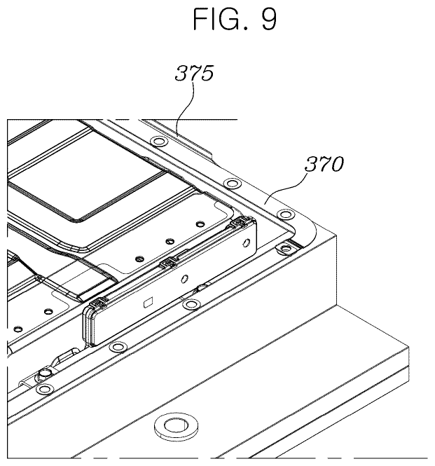

FIG. 9 is an enlarged view of the rear of a battery lower case. Referring to FIG. 9, the battery lower case 300 may include a rear member 370 provided at a rear end of the battery lower case 300 and forming a rear wall of the battery lower case 300. Further, a stopper 375 may be formed on the top of the rear member 370 and extended in the direction perpendicular to the ground, thereby stopping the sliding of the battery upper case 400. In other words, while the guide portion 355 guides the sliding of the battery upper case 400 to start, the stopper 375 guides the sliding of the battery upper case 400 to end.

Although specific embodiments of the disclosure have been illustrated and described as above, various modifications and changes can be made by a person having ordinary knowledge in the art without departing from the scope of technical ideas defined by the appended claims.

What is claimed is:

1. A battery case comprising:
a plurality of battery cells stacked on one another and configured to be accommodated in a battery lower case;
an upper cover covering an upper portion of the stacked battery cells;
at least one first bracket including:
a first end and a second end provided to be in contact with an upper surface of the upper cover, and
a middle portion spaced apart from the upper surface of the upper cover to form an insertion space; and
a battery upper case provided above the battery lower case and including a second bracket provided on a lower surface thereof,
wherein the second bracket comprises a first end to be inserted into the insertion space formed between the upper surface of the upper cover and the at least one first bracket.

2. The battery case of claim 1, further comprising:
at least one foam pad provided between a bottom of the middle portion of the at least one first bracket and a top of the upper cover and configured to face the middle portion and to absorb vibration.

3. The battery case of claim 1, wherein the second bracket comprises a second end being in contact with the lower surface of the battery upper case, and
wherein the first end of the second bracket is bent, extending downwards from the second end, and inserted into the insertion space.

4. The battery case of claim 1, wherein a sensing printed circuit board (PCB) for detecting states of the battery cells is provided above a central portion of the stacked battery cells, and comprises a temperature sensor to detect temperature of the battery cells.

5. The battery case of claim 1, wherein the upper cover comprises a protruding portion formed at a central position on the upper surface thereof and disposed to be higher than a surrounding portion of the upper surface.

6. The battery case of claim 5, wherein the at least one first bracket includes a pair of first brackets, and the protruding portion is disposed between the pair of first brackets.

7. The battery case of claim 6, wherein the pair of first brackets face each other, and the protruding portion is spaced apart from each first bracket of the pair of first brackets.

8. The battery case of claim 5, wherein the middle portion of the at least one first bracket is formed to have the same height as or be lower than the protruding portion.

9. The battery case of claim 1, wherein the battery lower case comprises a longitudinal member crossing the battery lower case in a lengthwise direction of the battery lower case, and a transverse member crossing the battery lower case in a widthwise direction of the battery lower case, such that an accommodating space is formed to accommodate a battery module including the stacked battery cells therein.

10. The battery case of claim 9, wherein each of the longitudinal member and the transverse member is provided as a single member to divide an inside of the battery lower case into four accommodating spaces, each of which accommodates the battery module therein.

11. The battery case of claim 1, wherein the battery lower case comprises:
a management space located at a front end and accommodating a battery management unit therein, and
side members provided at sides of the management space and configured to form outer walls.

12. The battery case of claim 11, further comprising a guide portion formed at a first end portion of a top of the side member, extended in a direction perpendicular to the ground, and guiding the battery upper case to slide.

13. The battery case of claim 12, wherein the guide portion is configured to extend along a lengthwise direction of the battery lower case, excluding a second end portion of the side member.

14. The battery case of claim 1, wherein the battery lower case comprises a rear member provided at a rear end of the battery lower case and forming a rear wall of the battery lower case.

15. The battery case of claim 14, wherein the rear member comprises a stopper formed at a top thereof, extended in a direction perpendicular to the ground, the stopper configured to stop sliding of the battery upper case.

16. The battery case of claim 1, wherein the battery lower case comprises:
a longitudinal member crossing the battery lower case in a lengthwise direction of the battery lower case,
a transverse member crossing the battery lower case in a widthwise direction of the battery lower case, and
sidewall members facing the longitudinal member and forming side walls of the battery lower case.

17. The battery case of claim 16, wherein:
the longitudinal member, the transverse member, and the sidewall members form an accommodating space inside the battery lower case to accommodate a battery module including the plurality of battery cells,
the at least one first bracket is provided on the upper surface of the upper cover corresponding to the accommodating space, and
the second bracket is provided on the lower surface of the battery upper case corresponding to the accommodating space.
